(19) United States
(12) Patent Application Publication
(10) Pub. No.: US 2009/0141943 A1
(43) Pub. Date: Jun. 4, 2009

(54) ANALYZING BOREHOLE BY AUTOMATICALLY EVALUATING PREDICTED BOREHOLE FAILURE IMAGE

(75) Inventor: Heng Liu, Beijing (CN)

Correspondence Address: SCHLUMBERGER INFORMATION SOLUTIONS, 5599 SAN FELIPE, SUITE 1700, HOUSTON, TX, 77056-2722, US

(73) Assignee: Schlumberger Technology Corporation, Houston, TX (US)

(21) Appl. No.: 11/947,545

(22) Filed: Nov. 29, 2007

(51) Int. Cl. G06K 9/00

(52) U.S. Cl. 382/109

(57) ABSTRACT

A method, system and computer program product for analyzing a borehole drilled in a reservoir are disclosed. A method may include: providing a real borehole image; providing a predicted borehole failure image generated based on an earth formation model; edge detecting the real borehole image to generate an edge detected real borehole image; extracting sub-images from the edge detected real borehole image, each sub-image including an image feature of the edge detected real borehole image oriented in a spatial direction different than that of at least one other sub-image; matching each sub-image to the predicted borehole failure image to determine a matching sub-image; and comparing the predicted borehole failure image with the matching sub-image to determine an accuracy of the predicted borehole failure image.

### FIELD OF THE INVENTION

The disclosure relates in general to reservoir development, and more particularly to analyzing a borehole drilled in a reservoir.

### BACKGROUND OF THE INVENTION

During the drilling of a borehole, problems such as breakouts or collapses may develop within or about the borehole, which may cause borehole failures. In order to avoid a borehole failure, an accurate and efficient diagnosis of the causes of the borehole failure is necessary. Conventionally, a borehole image such as formation micro image (FMI) may be used to detect a borehole problem. Using different tools based on sonic, resistivity or other physical mechanisms, the borehore's inside formation, for example, the fabric and texture, may be detected. For example, wireline tools may be lowered into a drilled oil or gas well to measure either the electrical conductivity of the borehole wall or the sonic travel time and amplitude. Based on these measurements, a borehole image with special defined color and brightness can be generated, which may show borehole features such as the bedding and fractures. By examining the borehole image, experts can detect a cause of borehole failure that occurs along the borehole.

In a borehole analysis, an earth formation model may be built and a predicted borehole failure image may be generated based on the earth formation model as an alternative to the examination of a real borehole image. To calibrate the earth formation model, conventionally, the predicted failure image is manually compared with a real borehole image such as a FMI image. In doing so, an expert is required to eye examine the real borehole image to identify the causes of borehole failures among all other structure features of the borehole through personal experience.

### SUMMARY OF THE INVENTION

A first aspect of the invention is directed to a method for analyzing a borehole drilled in a reservoir, the method comprising: providing a real borehole image; providing a predicted borehole failure image generated based on an earth formation model; edge detecting the real borehole image to generate an edge detected real borehole image; extracting sub-images from the edge detected real borehole image, each sub-image including an image feature of the edge detected real borehole image oriented in a spatial direction different than that of at least one other sub-image; matching each sub-image to the predicted borehole failure image to determine a matching sub-image; and comparing the predicted borehole failure image with the matching sub-image to determine an accuracy of the predicted borehole failure image.

A second aspect of the invention is directed to a system for analyzing a borehole drilled in a reservoir, the system comprising: means for receiving a real borehole image and a predicted borehole failure image generated based on an earth formation model; means for edge detecting the real borehole image to generate an edge detected real borehole image; means for extracting sub-images from the edge detected real borehole image, each sub-image including an image feature of the edge detected real borehole image oriented in a spatial direction different than that of at least one other sub-image; means for matching each sub-image to the predicted borehole failure image to determine a matching sub-image; and means for comparing the predicted borehole failure image with the matching sub-image to determine an accuracy of the predicted borehole failure image.

A third aspect of the invention is directed to a computer program product for analyzing a borehole drilled in a reservoir, comprising: computer usable program code which, when executed by a computer system, enables the computer system to: receive a real borehole image and a predicted borehole failure image generated based on an earth formation model; edge detect the real borehole image to generate an edge detected real borehole image; extract sub-images from the edge detected real borehole image, each sub-image including an image feature of the edge detected real borehole image oriented in a spatial direction different than that of at least one other sub-image; match each sub-image to the predicted borehole failure image to determine a matching sub-image; and compare the predicted borehole failure image with the matching sub-image to determine an accuracy of the predicted borehole failure image.

A fourth aspect of the invention is directed to a method of providing a system for analyzing a borehole drilled in a reservoir, the method comprising: at least one of: creating, maintaining, deploying or supporting a computer infrastructure operable to: receive a real borehole image and a predicted borehole failure image generated based on an earth formation model; edge detect the real borehole image to generate an edge detected real borehole image; extract sub-images from the edge detected real borehole image, each sub-image including an image feature of the edge detected real borehole image oriented in a spatial direction different than that of at least one other sub-image; match each sub-image to the predicted borehole failure image to determine a matching sub-image; and compare the predicted borehole failure image with the matching sub-image to determine an accuracy of the predicted borehole failure image.

Other aspects and features of the present invention, as solely defined by the claims, and additional advantages of the invention will become apparent to those skilled in the art upon reference to the following non-limited detailed description taken in conjunction with the provided figures.

### BRIEF DESCRIPTION OF THE DRAWINGS

The disclosure is illustrated by way of example and not intended to be limited by the figures of the accompanying drawings in which like references indicate similar elements and in which:

FIG. 1 shows a block diagram of a system.

FIG. 2 shows a flow diagram of the operation of a borehole analysis system.

FIG. 3 shows schematically a real borehole image, a predicted borehole failure image and a noise reduction process.

FIG. 4 shows schematically an edge detection process.

FIG. 5 illustrates schematically an extraction process.

FIG. 6 illustrates a matching process.

FIG. 7 illustrates a comparing process.

It is noted that the drawings are not to scale.

### DETAILED DESCRIPTION OF THE DISCLOSURE

Advantages and features of the present invention and methods of accomplishing the same may be understood more readily by reference to the following detailed description of exemplary embodiments and the accompanying drawings. The present invention may, however, be embodied in many different forms and should not be construed as being Limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

### 1. System Overview

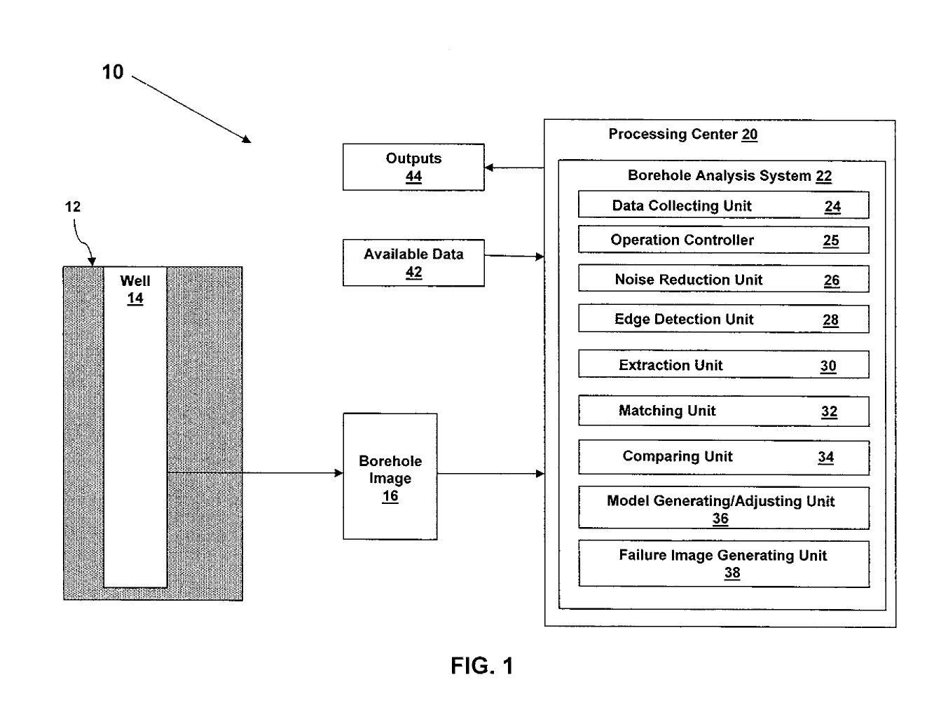

Referring to FIG. 1, a block diagram of an illustrative system 10 for analyzing a borehole of a drilled well 14 in a reservoir 12 is shown. Reservoir 12 may include any reservoir such as, but not limited to, an oil reservoir, a gas reservoir, a coal reservoir, and an underground water reservoir. A real borehole image 16 may be obtained from drilled well 14 and may be communicated to a processing center 20 including a borehole analysis system 22. Real borehole image 16 may be obtained by any now known or later developed mechanism. For example, an electrical dipmeter tool, an acoustic image tool, and/or an electrical image and dipmeter tool (not shown) may be used to obtain real borehole image 16.

Borehole analysis system 22 may include a data collecting unit 24; an operation controller 25; a noise reduction unit 26; an edge detection unit 28; an extraction unit 30; a matching unit 32; a comparing unit 34; a model generating/adjusting unit 36; and a failure image generating unit 38.

Besides real borehole image 16, processing center 20 may also receive input of available data 42. Available data 42 may include available earth formation models of reservoir 12, and/or available provided borehole failure images of drilled well 14. A predicted borehole failure image is generated based on an earth formation model, and represents structure features of a borehole that may cause a borehole failure. Available data 42 may also include dynamic borehole data, such as oriented caliper and borehole trajectory data, for borehole analysis system 22 to analyze the borehole problems of drilled well 14, such as breakouts and collapse.

Outputs 44 of processing center 20 may include an earth formation model, a predicted borehole failure image, or an evaluation of a provided earth formation model and/or a provided predicted borehole failure image. Outputs 44 may be used in analyzing the borehole of drilled well 14 as appreciated by a person with ordinary skill in the art.

According to an embodiment, processing system 20 may be implemented by a computer system. The computer system can comprise any general purpose computing article of manufacture capable of executing computer program code installed thereon to perform the process described herein. The computer system can also comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. The operation of borehole analysis system 22 will be described herein in detail.

### 2. Operation Methodology

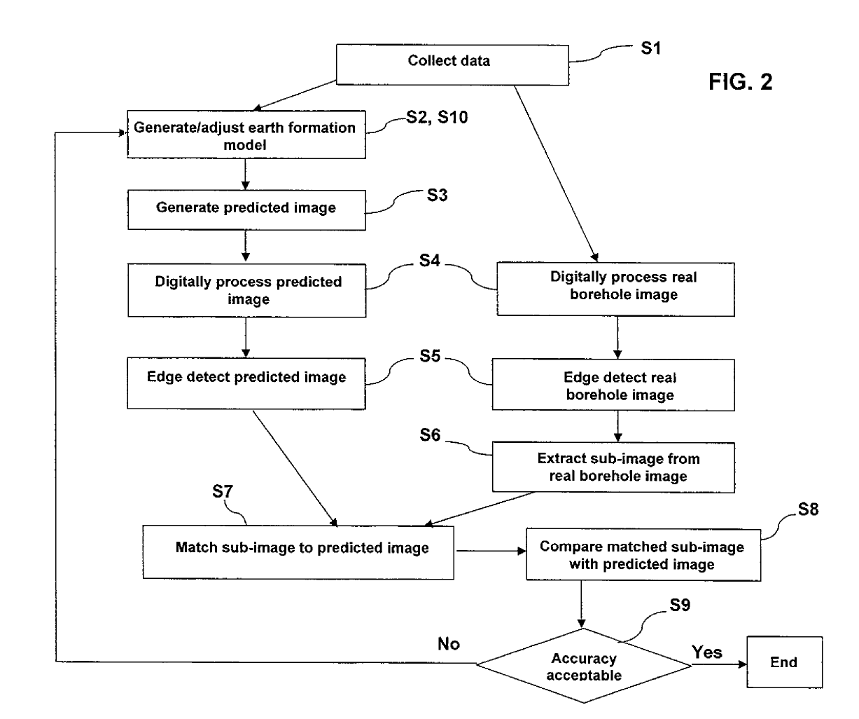

FIG. 2 shows embodiments of the operation of borehole analysis system 22. Referring to FIGS. 1-2, collectively, in process S1, data collecting unit 24 collects data. The data collected may be real borehole image 16 and available data 42 including an initial earth formation model and/or a predicted borehole failure image. Initial earth formation model and predicted borehole failure image are not necessary for the operation of borehole analysis system 22 because borehole analysis system 22 optionally may perform processes to generate an initial earth formation model and/or a predicted borehole failure image.

In process S2, optionally, model generating/adjusting unit 36 generates an earth formation model (initial) for the earth formation of reservoir 12. The earth formation model may be generated using any now known or later developed method and based on any information. For example, openhole log data and dynamic flow (formation) testing data may be used to generate the initial earth formation model.

In process S3, optionally, failure image generating unit 38 generates a predicted borehole failure image based on the initial earth formation model established in process S2. The detail of generating a predicted borehole failure image based on an earth formation model is not necessary for an appreciation of the disclosure and is thus not provided for brevity. Note that processes S2-S3 are all optional and borehole analysis system 22 may operate on provided initial earth formation model and generate a predicted borehole failure image based thereon, or may operate on a provided predicted borehole failure image as will be described herein.

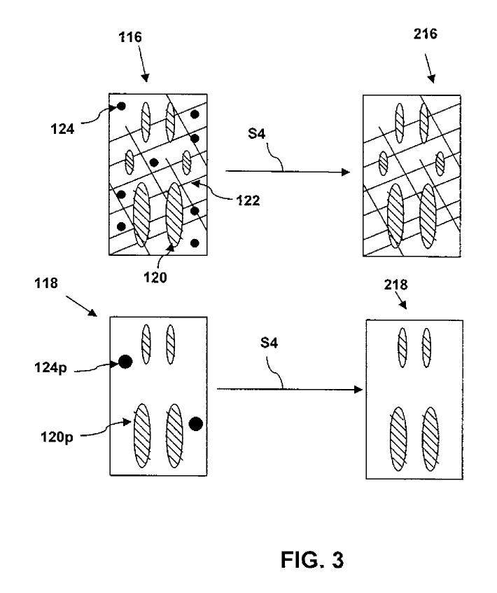

In process S4, noise reduction unit 26 digitally processes the predicted borehole failure image and the real borehole image 16 to, e.g., reduce noise pixels (noises). FIG. 3 shows schematically a real borehole image (real image) 116 and a predicted borehole failure image (predicted image) 1118, and the noise reduction process. As shown in FIG. 3, real image 116 may include failure image features 120, other image (e.g., textures or channels) features 122 and noises 124. Predicted image 118 may include failure image features 120p and noises 124p. An image feature (failure image feature or other image feature) refers to a feature in an image that represents a structure feature in the earth formation of reservoir 12. After process S4, noises 124 and 124p are removed from real image 116 and predicted image 118, respectively, to generate real image 216 and predicted image 218. Other digital processing of real image 116 and/or predicted image 118 is also possible and falls within the scope of the invention.

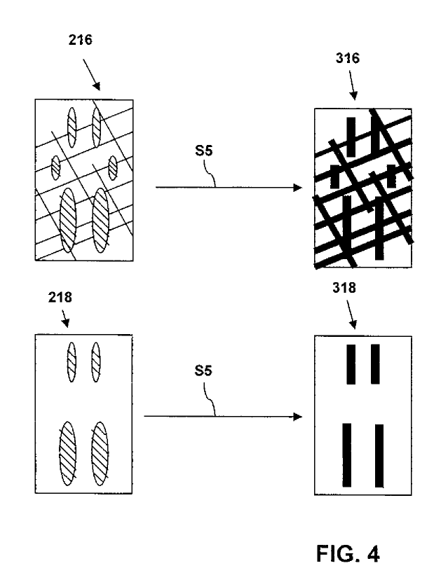

In process S5, edge detection unit 28 edge detects the image features in real image 216 and predicted image 218. Any method may be used in the edge detection. For example, a gradient method or a Laplacian operator method may be used in the edge detection. FIG. 4 illustrates the edge detection of real image 216 and predicted image 218 to generate real image 316 and predicted image 318, respectively. In FIG. 4, all image features are shown with a rectangular shape after the edge detection for illustrative purposes. It should be appreciated that the edge detection process is not limited by any specific shape of the edge detected image features.

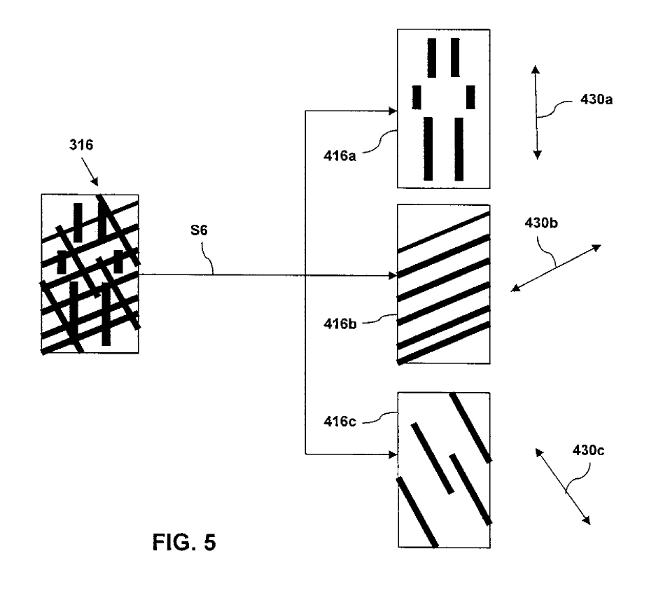

In process S6, extraction unit 30 extracts sub-images from the edge detected real image. Each sub-image includes an image feature in real image 316 which is oriented in a particular spatial direction. That is, image features in two different sub-images are oriented in two different spatial directions. Any method may be used in the. For example, the gradient method or the Laplacian operator method may be used in the extraction. The gradient method may use, for example, three gradient directional templates: vertical, 45 degree and horizontal, for the extraction. Each template is a three pixel filter such as 0, 1, 0. After the filtering (minus pixel value with real image 316) using each directional template, sub-images of the real image 316 may be obtained in the directions of the filter templates. If more gradient filter templates are used to filter real image 316 in more direction degrees, such as 0, 15, 30, 45, 60, . . . 345 degrees, more detailed directional sub-images may be obtained. The Laplacian operator method may work in similar manners. FIG. 5 illustrates the extraction process operated on real image 316 to generate sub-images 416a, 416b and 416c (each may be generally referred to as sub-image 416) oriented in spatial directions 430a, 430b, and 430c, respectively,

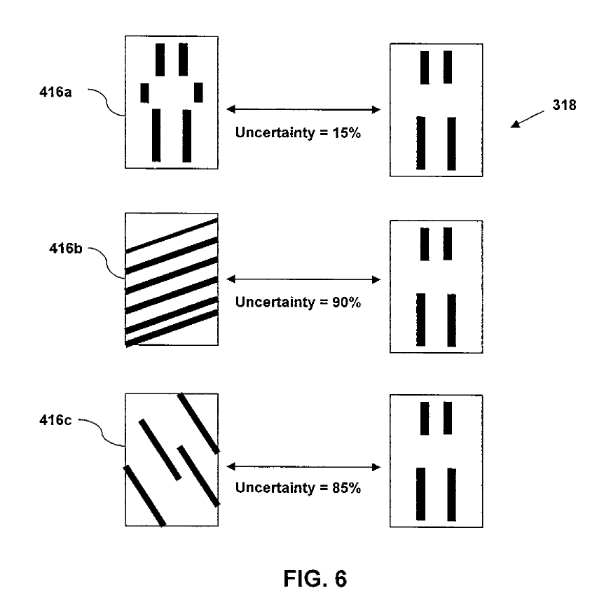

In process S7, matching unit 32 matches each sub-image 416 to predicted image 318 to determine a matching sub-image. Any method may be used in the matching process. For example, the pattern recognition methods, such as a minimum distance classifier, may be used to determine the matching sub-image 416. Usually no sub-image 416 can completely (i.e., 100 percent) match predicted image 318. A matching algorithm may obtain an uncertainty value for each sub-image 416, which represents the difference between the sub-image 416 and predicted image 318. The sub-image 416 with the lowest uncertainty value will be determined as the matching sub-image 416. As illustratively shown in FIG. 6, sub-image 416a includes an uncertainty value of 15 percent, which is lower than the uncertainty values of sub-images 416b and 416c. As such, sub-image 416a will be determined as the matching sub-image 416. Assuming that predicted image 318 is considerably accurate, which is generally the case under the current technology in modeling earth formations, the matching sub-image (416a) can be treated as representing the borehole failure structures.

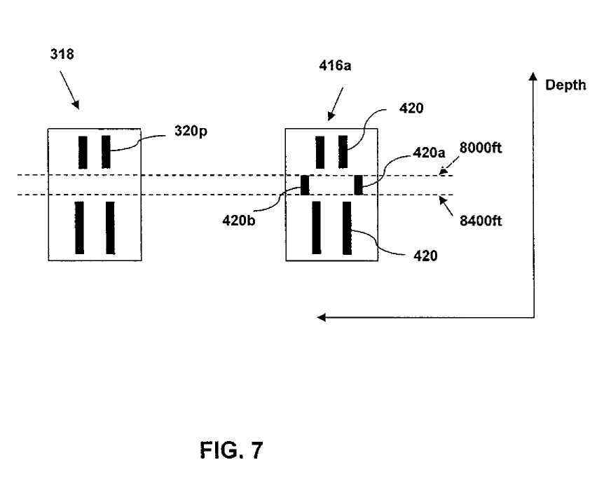

In process S8, comparing unit 34 compares predicted image 318 with matching sub-image 416a to determine an accuracy of predicted image 318. In the comparing, failure image features 320p of predicted image 318 are compared with failure image features 420 of matching sub-image 416a at each depth (or depth range) to detect the differences therebetween, if any. As illustratively shown in FIG. 7, comparing unit 34 may detect that matching sub-image 416a includes two failure structures 420a, 420b (e.g., fractures) at depth range between 8000 feet to 8400 feet, which are not represented in predicted image 318. This may show that predicted image 318 (and thus the initial earth formation model) is inaccurate at this depth range. According to an embodiment, in determining the difference between matching sub-image 416a and predicted image 318 at a specific depth, the overall uncertainty value of matching sub-image 416a may also be considered.

In process S9, operation controller 25 determines whether the accuracy of predicted image 318 is acceptable. If “yes”, operation controller 25 ends the operation of borehole analysis system 22 and outputs the earth formation model and/or the predicted images 118, 218, 318 to analyze the dynamic characteristics of drill well 14 of reservoir 12. If “no”, operation controller 40 controls the operation to proceed to process S10.

In process S10, optionally, model generating/adjusting unit 36 adjusts the initial earth formation model based on the results of the comparison in process S8 to eliminate the inaccuracy of predicted image 318. Note that process S10 is optional. In the case the initial earth formation model and/or the initial predict failure image are provided as available data 42, borehole analysis system 22 may just analyze the determined differences between predicted image 318 and matching sub-image 416a to generate an analysis report. The analysis report may be communicated back to a service requestor, e.g., the person who provides the initial earth formation model and/or the initial predicted failure image, for the service requester to perform further actions accordingly.

### 3. Conclusion

While shown and described herein as a method and system for analyzing a borehole drilled in a reservoir, it is understood that the invention further provides various additional features. For example, in an embodiment, the invention provides a program product stored on a computer-readable medium, which when executed, enables a computer infrastructure to analyze a borehole drilled in a reservoir. To this extent, the computer-readable medium includes program code, such as borehole analysis system 22 (FIG. 1), which implements the process described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory and/or other storage system, and/or as a data signal traveling over a network (e.g., during a wired/wireless electronic distribution of the program product).

In addition, a method of providing a system for analyzing a borehole drilled in a reservoir can be included. In this case, a computer infrastructure, such as process center 20 (FIG. 1), can be obtained (e.g., created, maintained, deploying, having been made available to, supported, etc.) and one or more systems for performing the process described herein can be obtained (e.g., created, purchased, used, modified, etc.) and deployed to the computer infrastructure. To this extent, the deployment of each system can comprise one or more of: (1) installing program code on a computing device, such as process center 20 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic f/O system/driver for a particular computing and/or I/O device, and the like. Further, it is understood that the terms “component” and “system” are synonymous as used herein and represent any combination of hardware and/or software capable of performing some function(s).

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the disclosure has been particularly shown and described with reference to exemplary embodiments thereof, it will be understood by those of ordinary skilled in the art that various changes in form and details may be made therein without departing from the spirit and scope of the present invention as defined by the claims. In addition, those of ordinary skill in the art appreciate that any arrangement which is calculated to achieve the same purpose may be substituted for the specific embodiments shown and that the invention has other applications in other environments.

We claim:

1. A method for analyzing a borehole drilled in a reservoir, the method comprising:
providing a real borehole image;
providing a predicted borehole failure image generated based on an earth formation model;
edge detecting the real borehole image to generate an edge detected real borehole image;
extracting sub-images from the edge detected real borehole image, each sub-image including an image feature of the edge detected real borehole image oriented in a spatial direction different than that of at least one other sub-image;
matching each sub-image to the predicted borehole failure image to determine a matching sub-image; and
comparing the predicted borehole failure image with the matching sub-image to determine an accuracy of the predicted borehole failure image.

2. The method of claim 1, further comprising digitally processing at least one of: the real borehole image or the predicted borehole failure image to eliminate a noise pixel.

3. The method of claim 1, further comprising edge detecting the predicted borehole failure image.

4. The method of claim 1, wherein the comparing includes determining a difference between the predicted borehole failure image and the matching sub-image at each of a plurality of depths.

5. The method of claim 4, wherein an overall uncertainty between the predicted borehole failure image and the matching sub-image is considered in the determination of the difference at each of the plurality of depths.

6. The method of claim 1, further comprising adjusting the earth formation model based on the determined accuracy.

7. A system for analyzing a borehole drilled in a reservoir, the system comprising:
means for receiving a real borehole image and a predicted borehole failure image generated based on an earth formation model;
means for edge detecting the real borehole image to generate an edge detected real borehole image;
means for extracting sub-images from the edge detected real borehole image, each sub-image including an image feature of the edge detected real borehole image oriented in a spatial direction different than that of at least one other sub-image;
means for matching each sub-image to the predicted borehole failure image to determine a matching sub-image; and
means for comparing the predicted borehole failure image with the matching sub-image to determine an accuracy of the predicted borehole failure image.

8. The system of claim 7, further comprising means for digitally processing at least one of: the real borehole image or the predicted borehole failure image to eliminate a noise pixel.

9. The system of claim 7, wherein the edge detecting mean further edge detects the predicted borehole failure image.

10. The system of claim 7, wherein the comparing means determines a difference between the predicted borehole failure image and the matching sub-image at each of a plurality of depths.

11. The system of claim 10, wherein the comparing means considers an overall uncertainty between the predicted borehole failure image and the matching sub-image in determining the difference at each of the plurality of depths.

12. The system of claim 7, further comprising means for adjusting the earth formation model based on the determined accuracy.

13. A computer program product for analyzing a borehole drilled in a reservoir, comprising:
computer usable program code which, when executed by a computer system, enables the computer system to:
receive a real borehole image and a predicted borehole failure image generated based on an earth formation model;
edge detect the real borehole image to generate an edge detected real borehole image;
extract sub-images from the edge detected real borehole image, each sub-image including an image feature of the edge detected real borehole image oriented in a spatial direction different than that of at least one other sub-image;
match each sub-image to the predicted borehole failure image to determine a matching sub-image; and
compare the predicted borehole failure image with the matching sub-image to determine an accuracy of the predicted borehole failure image.

14. The computer program product of claim 13, wherein the program code is further configured to enable the computer system to digitally process at least one of: the real borehole image or the predicted borehole failure image to eliminate a noise pixel.

15. The computer program product of claim 13, wherein the program code is further configured to enable the computer system to edge detect the predicted borehole failure image.

16. The computer program product of claim 13, wherein the program code is configured to enable the computer system to determine a difference between the predicted borehole failure image and the matching sub-image at each of a plurality of depths.

17. The computer program product of claim 16, wherein the program code is further configured to enable the computer system to consider an overall uncertainty between the predicted borehole failure image and the matching sub-image in determining the difference at each of the plurality of depths.

18. The computer program product of claim 13, wherein the program code is further configured to enable the computer system to adjust the earth formation model based on the determined accuracy.

19. A method of providing a system for analyzing a borehole drilled in a reservoir, the method comprising:
at least one of: creating, maintaining, deploying or supporting a computer infrastructure operable to:
receive a real borehole image and a predicted borehole failure image generated based on an earth formation model;
edge detect the real borehole image to generate an edge detected real borehole image;
extract sub-images from the edge detected real borehole image, each sub-image including an image feature of the edge detected real borehole image oriented in a spatial direction different than that of at least one other sub-image;
match each sub-image to the predicted borehole failure image to determine a matching sub-image; and
compare the predicted borehole failure image with the matching sub-image to determine an accuracy of the predicted borehole failure image.

20. The method of claim 19, wherein the computer infrastructure is further operable to determine a difference between the predicted borehole failure image and the matching sub-image at each of a plurality of depths.
